(19) United States
(12) Patent Application Publication
(10) Pub. No.: US 2013/0200237 A1
(43) Pub. Date: Aug. 8, 2013

(54) ATTACHABLE PAD FOR A SUPPORTER

(71) Applicant: Min Sik Park, Seoul (KR)

(72) Inventor: Min Sik Park, Seoul (KR)

(21) Appl. No.: 13/522,086

(22) PCT Filed: Oct. 29, 2010
(86) PCT No.: PCT/KR2010/007496

§ 371 Date: Jul. 13, 2012

(30) Foreign Application Priority Data
Oct. 28, 2010 (KR) 10-2010-0105811

(51) Int. Cl. A47B 95/04; F16B 45/00

(52) U.S. Cl. CPC A47B 95/043; F16B 45/00
USPC 248/304; 248/345.1

(57) ABSTRACT

An attachable pad for a support includes an attachable pad body, an attachment sheet boned to the attachable pad body, a cap covering the attachable pad body, an operation cap fixing the cap to the attachable pad body, and a support-connecting fixing ring between the cap and the operation cap. A main body wing is integrally provided in the attachable pad body between the attachment sheet and the attachable pad body. A fixing screw nut is integrally molded to the attachable pad body. A fixing screw bolt is separated from the nut in order to fix the fixing screw bolt to the fixing screw nut. A support section is provided inside the cap to support the body wing. The support section can press the body wing together with the body to the surface of an object while a circumferential pillar is pressing the body to the surface of the object.

### TECHNICAL FIELD

The present invention relates to an attachable pad, and more particularly, to an attachable pad that can overcome the drawbacks of an attachable pad of the related art, namely, that the supportable load is tightly limited when vacuum compression is used or that the sealing attachment is disabled as time passes or vacuum pressure is released when the attachable pad is based on sealing attachment. The attachable pad can complete the bonding of the sealing attachment as time passes, and thus semi-permanently maintain the attached state like the fixed state obtained by a physical means of fixing such as a nail. In addition, the attachable pad can be easily detached as required.

### BACKGROUND ART

As shown in FIG. 1a and FIG. 1b, a vacuum absorber, which is so-called as a first-generation vacuum compression pad, includes a body 120, which has a hollow section and a through-hole in the central portion thereof, a suction plate 143, which is seated in a front opening of the body 120, a bolt 141 fixed to the suction plate 143, and a rotary member 150, which is fastened to the bolt 141, which extends through a through-hole 151. The suction plate 143 is made of a soft rubber, and is attached by vacuum pressure that is generated in response to upward movement of the suction plate 143.

In the vacuum absorber 100 according to the related art as described above, the suction plate 143 must be made of a flexible and soft material. Therefore, there are the following problems: the weight that the vacuum absorber 100 can support is limited, the vacuum absorber 100 is dislodged when the load exceeds the limit, and the suction plate 143 is twisted and is easily detached when the load applied to the vacuum absorber 100 is directed perpendicular to the bolt 141.

In order to overcome the drawbacks of the first-generation vacuum compression pad, Korean Laid-Open Patent Publication No. 10-2006-0121626 is configured such that a packing 230 is seated on the outer circumference of the front opening of a body 220, and that a bolt 241 of a suction member 240 extends through a through-hole 221. In the state in which the bolt 241, which extends through the through-hole, is fastened with a rotary member 250, the bolt 241 rotates the rotary member 250 while tightly attaching the packing 230 to a tile or a wall surface. When the rotary member 250, inside of which the nut 251 is seated, rotates, the fastened bolt 241 presses the packing 230 using the suction plate 243 while being moved upwards. When the packing 230, which is supported by a fixing ring 225 of the body 220, is pressed against, its shape is deformed by a buffer groove 231 and a portion that composes a sealing attachment portion 233 protrudes forward, thereby blocking the movement of air. A space that is sealed hermetically is expanded by the suction plate 243 that is moving, thereby generating vacuum pressure. Therefore, a vacuum absorber 210 is fixed to a tile or a glass surface owing to the difference between the vacuum pressure that is created inside the absorber 210 and the ambient atmospheric pressure.

However, in the absorber using the difference between the vacuum pressure, which is created inside the absorber, and the ambient atmospheric pressure, there are drawbacks, namely, that the weight that the absorber can support is tightly limited due to the difference between the pressures, and that the attached state is easily disabled when a predetermined weight is exceeded.

In order to overcome the drawback that the weight that the related art using the absorber as described above can support is tightly limited, Korean Patent Publication No. 10-2008-0102500 introduces a new technology, namely a sealing attachment, as another related art of the invention. This technology was patented Sep. 21, 2009 and was assigned to the applicant of the invention on Dec. 3, 2009. As shown in FIG. 3a and FIG. 3b, this related art provides an attachable pad that includes a body 310, which has a screw portion, a sheet-shaped attachable portion 320, which extends outward from one end of the body, and a cap 340, which is provided in a screw portion 317 of the body such that it can screw. The cap 340 presses the attachable portion 320 to a surface 330 that is to be attached. An operation cap 341 is provided in the upper portion of the cap such as to screw into the screw portion 317 of the body, and an annular packing 345 is provided in the cross-section of the cap 340 that is attached to the attachable portion 320. The attachable portion 320 has a plurality of pieces of annular packing 345 on the surface 330 thereof, the pieces of packing being spaced apart from each other in a radial direction. The attachable portion 320 has a pointed portion 321 on one edge thereof.

When the attachable portion 320 described above is attached to the surface 330 that is to be attached by pressing on it, the attachable portion 320 is more tightly attached to the surface 330 that is to be attached by vacuum pressure that is created between the attachable portion 320 and the surface 330 that is to be attached, and/or the adhesive force of the attachable portion 320. Therefore, when the weight that the absorber of the related art using the creation of the vacuum pressure can support is 5 kg weight, the weight that the technology using the attachable portion 320 can support is 20 kg weight.

However, in the technology that uses the attachable portion 320, as is clearly shown in the cross-section of FIG. 3b, the annular packing 345 and a plurality of pieces of plastic packing 325 must be provided between the attachable portion 320 and the circumference of the cap 340 and between the attachable portion 320 and the surface 330 that is to be attached in order to prevent water, moisture or the like from penetrating between the attachable portion 320 and the surface that is to be attached. Here, the annular packing 345 and the plastic packing 325 are fixed along the circumference of the cap 340, between the cap and the attachable portion and between the attachable portion and the surface that is to be attached. Tightening the cap 340 in this fashion also pulls on the body 310 that is integrated with the screw portion 317. Accordingly, as time passes, the adhesive force of the attached surface of the body with respect to the surface that is to be attached decreases, such that the attachable pad is consequently detached.

To describe once more the problem that the strong attaching force of the related art decreases, the operation cap 341 in the upper portion of the cap 340 is provided such that it can screw with the screw portion 317 that is integrated to the body 310. Owing to the operation cap 341, the cap 340 can more strongly press the attachable portion 320 on the portion where the cap 340 is attached to the attachable portion 320 along the circumference of the cap. In this process, the operation cap 341 presses against the cap 340 using the force with which the body 310 is attached to the surface, i.e. an opposing force to the adhesive force of the body. As a result, this presses on the annular packing 345, which is positioned at the portion that is in contact with the attachable portion on the circumference of the cap 340, and the plurality of pieces of plastic packing 325, which are spaced apart from each other in a radial direction. Here, the force pressing upon the cap 340 counteracts the adhesive force of the body, thereby acting to pull the body 310 from the attached surface. As time passes, the attaching force of the body with respect to the surface that is to be attached weakens, so that the body is detached from the surface 330 that it is to be attached to.

The present invention has been made keeping in mind the above problems occurring in the related art, and is intended to provide an attachable pad, which can overcome the drawbacks of the attachable pad of the related art that use vacuum compression, namely, that the sealing attachment is disabled as time passes or the vacuum pressure is released. Instead, the attachable pad can complete the bonding of the sealing attachment as time passes and thus semi-permanently maintain the attached state like the fixed state obtained by a physical means of fixing such as a nail. In addition, the attachable pad can be easily detached as required.

### DISCLOSURE

### Technical Problem

Although the attachable pad of the related art described above has the merit of overcoming the problem that the weight that can be supported is tightly limited when it depends on the absorber unit of the related art, there are other problems in that the attachable pad cannot be attached for a long time, for example, 1 or 2 years. Consequently, in some cases, an object that is supported by the attachable pad may drop to the ground, thereby damaging itself or, what is worse, damaging other articles or people below the object. Therefore, it was necessary to invent an attachable pad that can support weight up to 20 kg weight or more while semi-permanently maintaining it in a secure state of attachment.

Another problem with the attachable pad of the related art described above is that the body is thicker than the attachment sheet and thus the melting temperature of the body becomes different from that of the attachment sheet when attaching the attachment sheet to the portion of the body that is intended to be attached to the surface that is to be attached in the manufacturing process thereof. Therefore it is not easy to attach the attachment sheet to the body. Most importantly, in the attachable pad of the related art, an annular packing and a plurality of pieces of plastic packing, which are spaced apart in a radial direction, are prepared along the circumference of the body in order to assist the attachment of the attachment sheet. The pieces of packing are pressed on by the cap in the portion of the circumference of the cap in which the cap is in contact with the attachment sheet, thereby preventing water, moisture and the like from entering. However, such an auxiliary unit makes the configuration of the attachable pad complicated, thereby creating some undesirable problems in the manufacture and maintenance of the attachable pad. It is therefore necessary to make an invention that facilitates the manufacture of the attachable pad and reduces the cost of manufacture by simplifying the configuration of the attachable pad.

### Technical Solution

In an aspect, the present invention provides an attachable pad for a support that includes an attachable pad body, an attachment sheet boned to the attachable pad body, a cap covering the attachable pad body, an operation cap fixing the cap to the attachable pad body, and a support-connecting fixing ring between the cap and the operation cap, such that an object that is to be supported can be supported by the sealing attachment of the attachment sheet. The attachable pad further includes a main body wing integrally provided in the attachable pad body between the attachment sheet and the attachable pad body. The main body wing includes a fixing screw nut integrally molded to the attachable pad body and a fixing screw bolt separated from the nut in order to fix the fixing screw bolt to the fixing screw nut by selecting a size and length thereof as required. A support section is provided inside the cap to support the body wing. When the cap is tightly attached to the body by the operation cap, the support section can press the body wing together with the body to a surface of the object that is to be attached while a circumferential pillar inside the cap is pressing the body to the surface of the object that is to be attached.

In another aspect, the present invention provides an attachable pad for a support comprising an attachable pad body, an attachment sheet boned to the attachable pad body, a fixing screw bolt integrally molded with the body, a cap covering the attachable pad body, an operation cap fixing the cap to the attachable pad body, and a support-connecting fixing ring between the cap and the operation cap, such that an object that is to be supported can be supported by the sealing attachment of the attachment sheet. The attachable pad further includes a main body wing integrally provided in the attachable pad body between the attachment sheet and the attachable pad body, and a support section provided inside the cap to support the body wing. When the cap is tightly attached to the body by the operation cap, the support section can press the body wing together with the body to a surface of the object that is to be attached while a circumferential pillar inside the cap is pressing the body to the surface of the object that is to be attached.

### Advantageous Effects

As described above, the configuration including the body wing 480 and the body wing support section 490 realizes significant effects that enable a load of 20 kg weight or more, which cannot be realized in the related art, to be semi-permanently attached using a unique adhesive force, which is referred to as the sealing attachment of the attachment sheet 420. In particular, in the sealing attachment configuration of the invention, the annular packing is provided in the attachment sheet contact portion on the circumference of the cap, which required essential components in the related art, and the auxiliary attachment configuration that provides a plurality of pieces of plastic packing between the attachment sheet and the surface that is to be attached is omitted.

In the invention, after the attachment sheet is tightly attached to the surface that is to be attached, the body wing is pressed upon by the support section inside the cap. Consequently, the body wing portion of the attachment sheet is also tightly attached to the surface that is to be attached, thereby preventing vacuum pressure from occurring. This, as a result, semi-permanently maintains the adhesive force that is unique to the attachment sheet.

In the attachable pad of the invention, after the attachment sheet is tightly attached to the surface that is to be attached using a hand or the like so that air is not introduced into the attachment sheet 420, air intake is blocked by fastening the body 410 and the body wing 480 to each other using the circumferential pillar 510, which is provided inside the cap, and the body wing support section 490. They do not detach from each other at temperatures ranging from 25° C. below zero to 85° C. above zero, and semi-permanent sealing attachment is possible.

### DESCRIPTION OF DRAWINGS

FIG. 1a and FIG. 1b are views schematically showing an absorber of the related art;

FIG. 2a and FIG. 2b are views schematically showing an improved vacuum absorber of the related art;

FIG. 3a is an exploded perspective view of an attachable pad of the related art;

FIG. 3b is a cross-sectional view schematically showing the state in which the attachable pad in the exploded perspective view of FIG. 3a is assembled and the annular packing is enlarged;

FIG. 4a is an exploded perspective view of an attachable pad according to an embodiment of the invention;

FIG. 4b is an explanatory view showing the state in which a fixing screw nut and a fixing screw bolt in the view of FIG. 4a are detached;

FIG. 5a is a view showing the state in which an attachable pad in the exploded perspective view of FIG. 4 is assembled and attached to an object wall;

FIG. 5b is a cross-sectional view taken along line A-A of the view of FIG. 5a;

FIG. 6 is an exploded perspective view of an attachable pad according to another embodiment of the invention;

FIG. 7a is a view showing the state in which an attachable pad in the exploded perspective view of FIG. 6 is assembled and attached to an object wall; and

FIG. 7b is a cross-sectional view taken along line B-B in FIG. 7a.

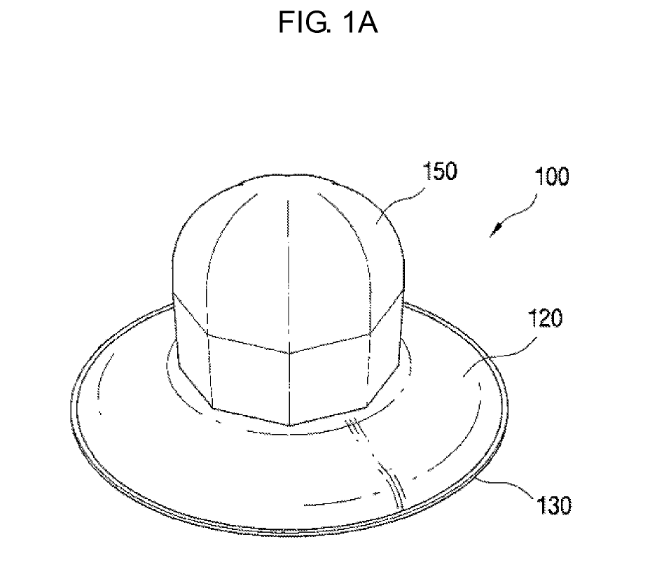

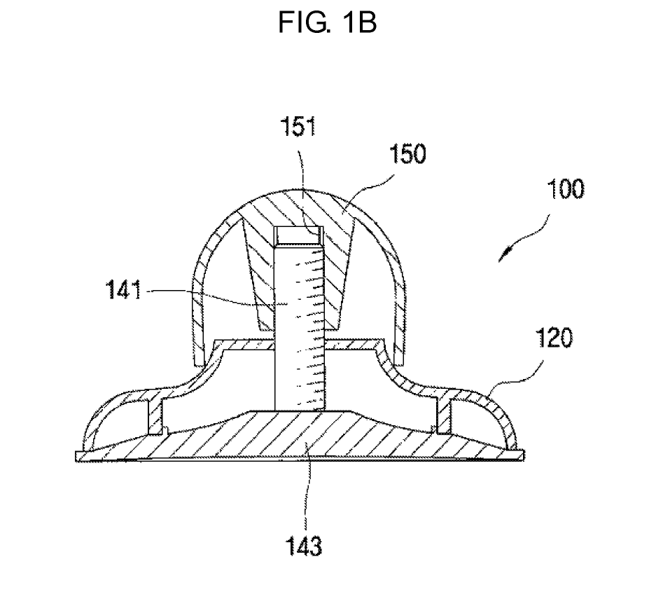

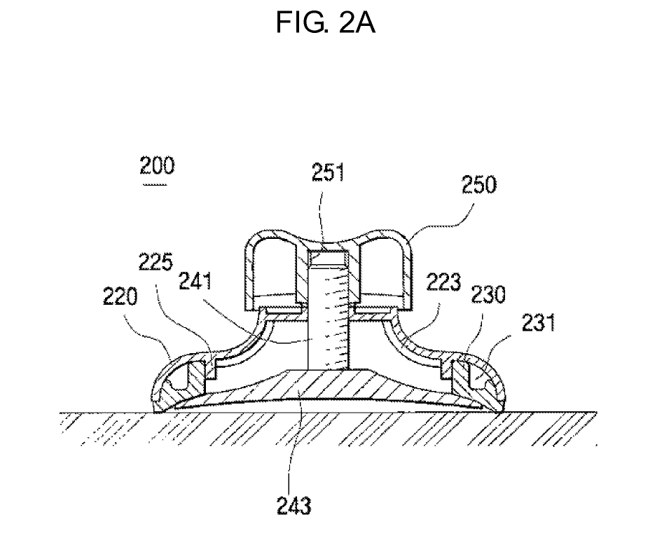

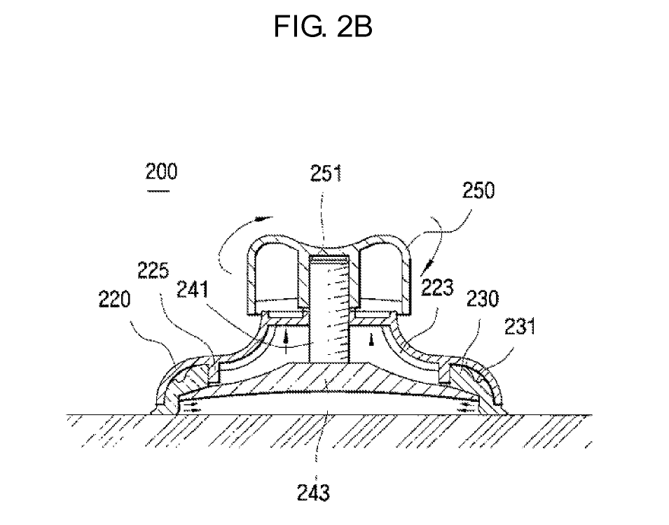

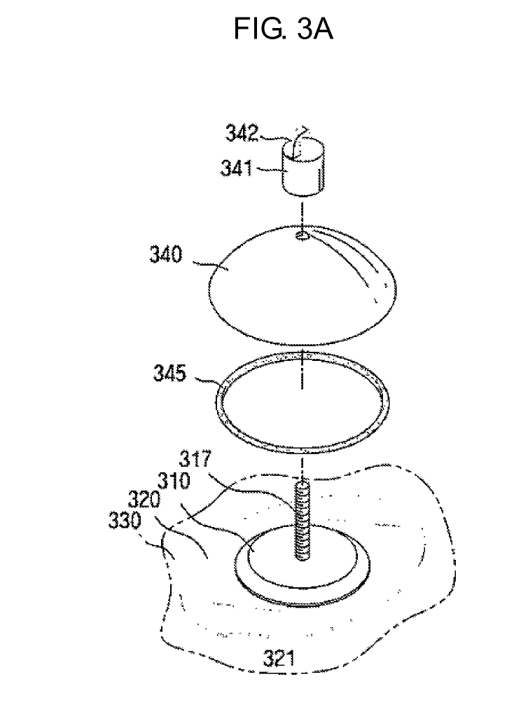

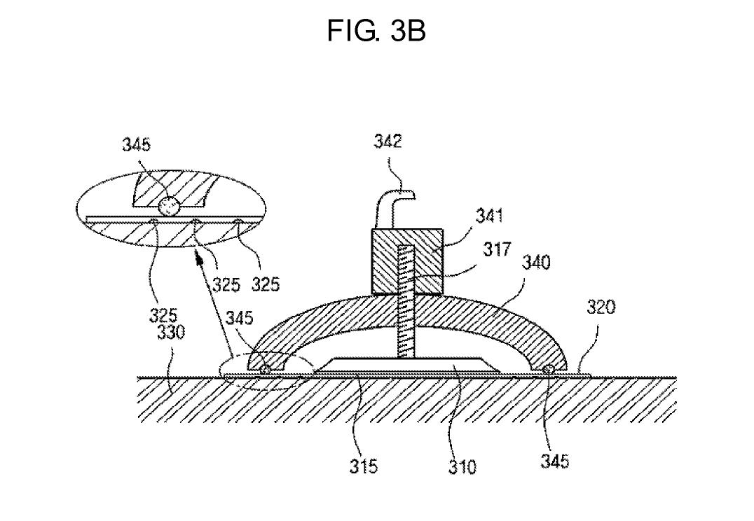

### MAJOR REFERENCE NUMERALS OF THE DRAWINGS

410: attachable pad body, 420: attachment sheet, 421: detachable tab, 430: fixing screw bolt,

440: fixing screw nut, 450: cap, 460: operation cap, 470: support-connecting fixing ring, 480: body wing, 490: support,

500: central recess inside cap, 510: circumferential pillar inside cap, 520: support-connecting fixing member

### MODE FOR INVENTION

Hereinafter, the present invention will be described in detail with reference to the accompanying drawings.

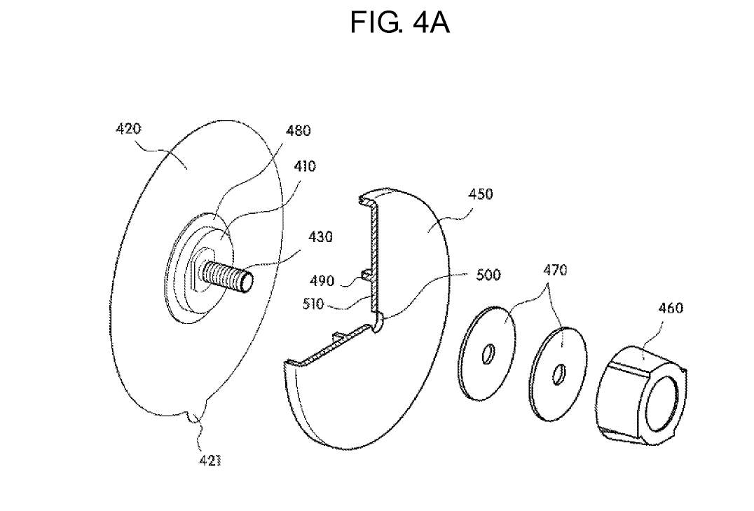

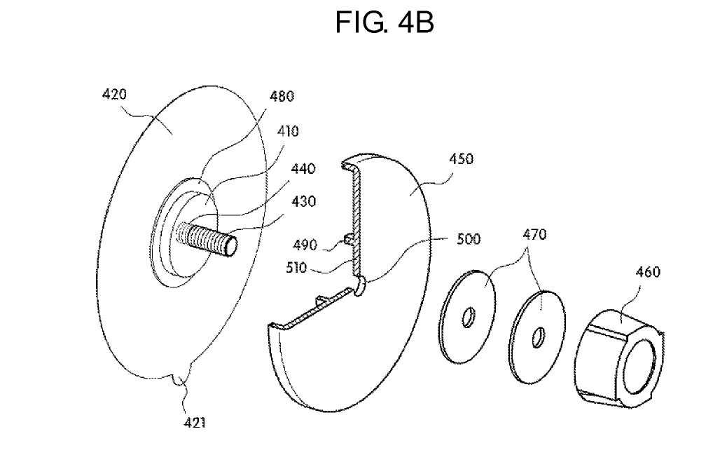

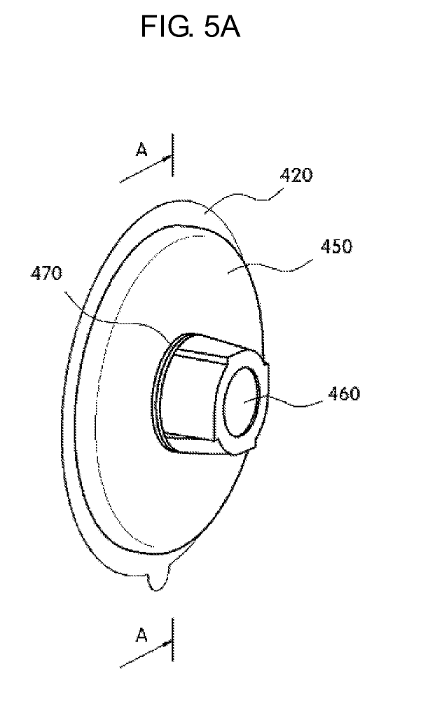

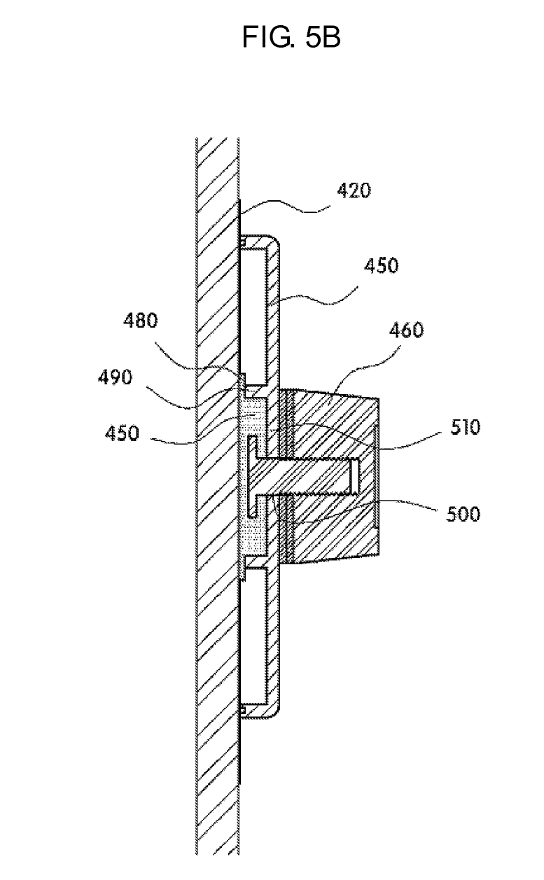

FIG. 4a is an exploded perspective view of an attachable pad according to an embodiment of the invention, and FIG. 4b is an explanatory view showing the state in which a fixing screw nut 440 and a fixing screw bolt 430 in the view of FIG. 4a are detached. In addition, FIG. 5a is a view showing the state in which the attachable pad in the exploded perspective view of FIG. 4 is assembled and attached to an object wall.

As shown in FIG. 4a, the basic configuration of the attachable pad of the invention includes an attachable pad body 410; an attachment sheet 420; the fixing screw bolt 430, which can be integrally molded with the body, or the fixing screw bolt 430, the length and size of which can be determined depending on the size and weight of an article that is to be supported on the fixing screw nut 440 via the attachable pad, while the fixing screw nut 440 is integrally molded to the body; a cap 450, which is fixed to the fixing screw bolt 430 to cover the attachable pad body 410; and an operation cap 460, which is screwed with the fixing screw bolt 430, thereby fixing the cap 450 to the body 410 via the fixing screw bolt 430.

A support-connecting fixing ring 470 is a part of a support connecting device that is fixed to the fixing screw bolt 430 between the cap 450 and the operation cap 460 such that the article that is to be supported can be supported. In addition, a detachable tab 421 is a knob with which the attachable pad, which is firmly attached, can be attached to and detached from the wall surface.

Returning to FIG. 4a, a body wing 480, which is integrated to the body 410, is provided between the attachment sheet 420 and the attachable pad body 410. The body wing 480 is molded from a material that is the same as the body, which is made of a synthetic resin. The diameter of the body wing ranges from 1.2 to 2 times the diameter of the body, and the thickness approximately ranges from 0.3 mm to 1 mm. In this fashion, the body wing is configured to allow easy high-frequency thermal fusion between the thin attachment sheet 420 and the body wing 480.

The body wing 480 is molded from the same material as the body, which is made of a synthetic resin, and the attachment sheet 420 is attached to the body wing by high-frequency thermal bonding, so that the attachment sheet 420 is tightly attached to the surface of the article that is to be attached. Even though the body wing 480 of the invention is much thinner than the body, when the fixing screw bolt 430 is supported in the state of being fixed to the body 410 in combination with the configuration of the support section 490 of the body wing 480 inside the cap 350, which will be described later, it is possible to provide a standing function to support the weight of the fixing screw bolt together with the supported article using counter movement in the body wing portion of the lower end of the circumference of the body. Therefore, it is possible to overcome the problem of the related art that the attachment sheet is deformed starting at the upper portion in the circumference of the body owing to the absence of the body wing portion.

In the related art, when the attachment sheet 420 and the body 410 are directly coupled without the body wing portion, and most importantly, when the attachable pad 410 is attached for a long time, the attachment sheet stays attached to the surface that is to be attached and the body portion of the attachable pad detaches from the surface that is to be attached, owing to the load that is continuously applied to the fixing screw bolt 430. Consequently, attachment sheet deformation occurs in the portion of the attachment sheet 420 in the upper portion of the circumference of the attachable pad body. Therefore, as time passes, the sealing attachment to the surface of the attachable sheet that is to be attached gradually loosens, starting with the circumferential portion of the attachable pad body. As a result, the attachable pad detaches from the surface that is to be attached, which is problematic.

In the invention, the support section 490 for the body wing 480 is formed inside the cap 450, and the height by which the wing support portion protrudes is greater than the height of the circumferential pillar 510 inside the cap. When the support section 490 applies force to the cap 450 using the operation cap 460 so that the cap 450 is tightly attached to the body 410, the inner structure of the cap 460 is constructed by adjusting the heights by which the circumferential pillar 510 and the wing support 490 protrude so that the support section 490 presses the body wing 480 against the surface that is to be attached while the circumferential pillar 510 also presses the body 410 against the surface that is to be attached. The circumferential pillar 510 inside the cap is positioned around the central recess 500 inside the cap through which the fixing screw bolt 430 in the central portion of the cap 450 passes. With the body wing support section 490 constructed as described above, after the attachment sheet 420 is tightly attached to the surface that is to the attached from the outer portion in the circumference of the body wing 480, the cap 450 is fastened to the attachable pad body 410 using the operation cap 460, so that the attachment sheet stays in the tightly attached state in the portion of the body wing 480. Indeed, the complete tightly attached state is formed over the entire attachment surface of the attachment sheet, owing to the attaching force between the surface that is to be attached and the attachment sheet 420, as time passes.

Therefore, the invention does not face the problem of the related art that ‘since the force that presses on the cap 340 originates from the attaching force of the body, the attaching force of the body with respect to the surface that is to be attached decreases as time passes, and consequently the body is detached from a surface 330 that is to be attached.’ Even when a considerable load is applied for a long time to the fixing screw bolt 430 via the support-connecting fixing ring 470, owing to the action of the body wing 480 and the support section 490 in the portion of the circumferential portion of the attachable pad body that is attached to the attachment sheet, the attachment sheet 470 is tightly attached to the surface that is to be attached, so that the attachable pad of the invention stays in the semi-permanently attached state.

With the configuration described above, the invention maintains the tightly attached state between the surface that is to be attached and the attachment sheet. The tightly attached state that remains in this fashion prevents vacuum pressure from occurring inside the attachment surface and has the effect of expelling minute pockets of gas that remain between the surface that is to be attached and the attachment sheet outward. Since vacuum pressure does not occur inside the attachment surface in this fashion, the surface that is to be attached and the attachment sheet are integrated. It is possible to essentially block water or moisture from entering from outside the attachment surface.

In this specification, vacuum pressure refers to negative (−) pressure, which is generated between the surface that is to be attached and the attachment sheet, and can act to take in moisture or the like from the outside.

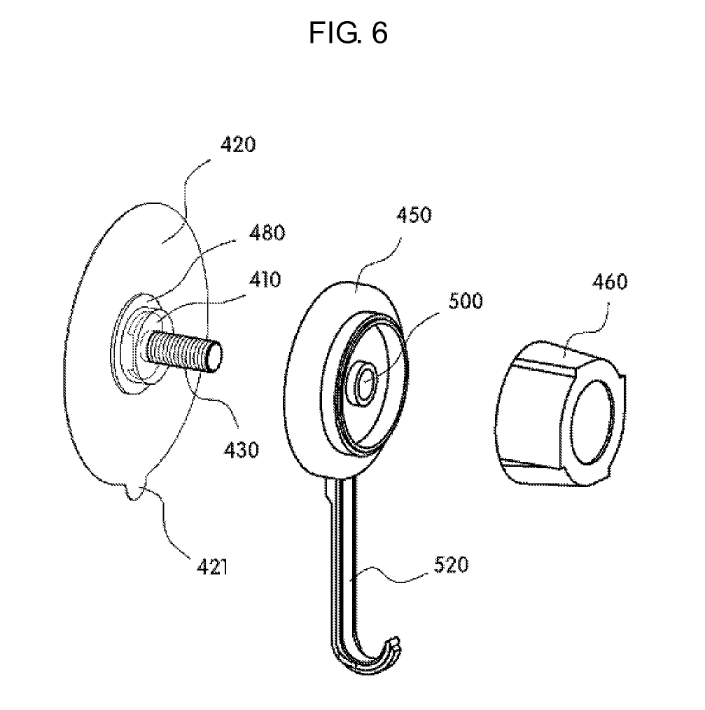

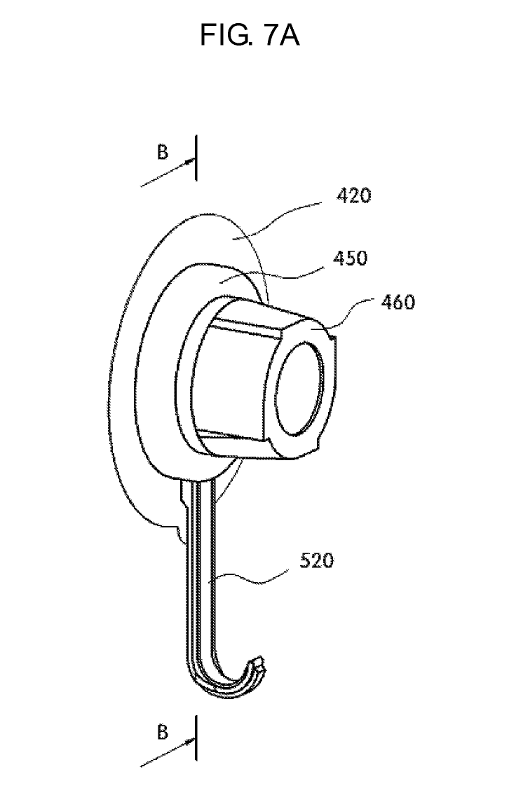

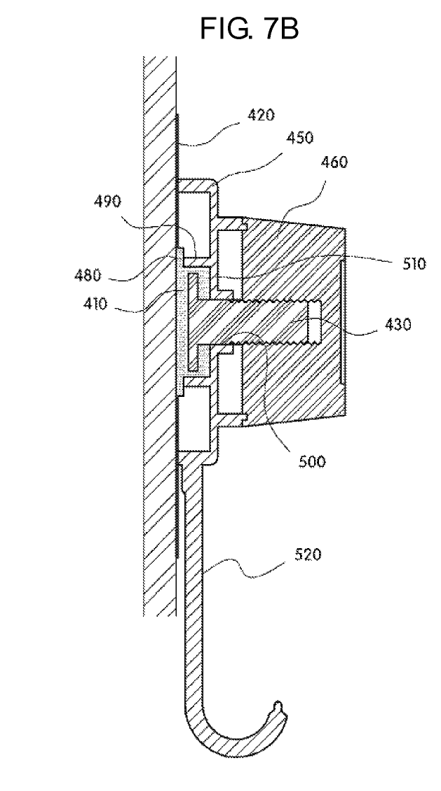

FIG. 6 is an exploded perspective view of an attachable pad according to another embodiment of the invention, FIG. 7a is a view showing the state in which an attachable pad in the exploded perspective view of FIG. 6 is assembled and attached to an object wall, and FIG. 7b is a cross-sectional view taken along line B-B in FIG. 7a.

As shown in FIG. 6, the attachable pad of the invention includes the attachable pad body 410; the attachment sheet 420; the fixing screw bolt 430, which can be integrally molded with the body, or the fixing screw bolt 430, the length and size of which can be determined depending on the size and weight of the article that is to be supported on the fixing screw nut 440 via the attachable pad, while the fixing screw nut 440 is integrally molded to the body; the cap 450, which is fixed to the fixing screw bolt 430 to cover the attachable pad body 410; and the operation cap 460, which is screwed with the fixing screw bolt 430, thereby fixing the cap 450 to the body 410 via the fixing screw bolt 430.

In the embodiment of the invention shown in FIG. 6, unlike the embodiment shown in FIG. 4a, a support-connecting fixing member 520 is integrally molded with the cap 450 without a separate support-connecting fixing ring. With this configuration, the cap 450 is fixed to the body 410 using the operation cap 460, so that the assembly of the attachable pad is complete.

1-4. (canceled)

5. An attachable pad for a support comprising:
an attachable pad body;
an attachment sheet bonded to the attachable pad body;
a cap covering the attachable pad body; and
an operation cap fixing the cap to the attachable pad body,
wherein a first pressing member for pressing the attachable pad body is provided inside the cap, such that, when the cap is tightly attached to the attachable pad body by the operation cap, the first pressing member presses the attachable pad body so that the attachable pad body is pressed against a surface to which the attachable body is to be attached.

6. The attachable pad of claim 5, further comprising a main body wing integrally provided in the attachable pad body between the attachment sheet and the attachable pad body and a second pressing member integrally formed inside the cap,
wherein the second pressing member presses the main body wing together with the attachable pad body against the surface to which the attachable body is to be attached while the first pressing member is pressing the attachable pad body to the surface that is to be attached, because of the operation cap.

7. The attachable pad of claim 6, wherein a height by which the second pressing member protrudes inside the cap is greater than a height by which the first pressing member protrudes.

8. The attachable pad of claim 6, wherein the body wing is molded from a material that is equal to that of the attachable pad body, and a diameter of the body wing ranges from 1.2 to 2 times a diameter of the attachable pad body.

9. The attachable pad of claim 8, wherein a thickness of the body wing ranges from 0.3 mm to 1 mm.

10. The attachable pad of claim 6, wherein the body wing is formed on the attachment sheet by high-frequency thermal bonding.

11. The attachable pad of claim 5, wherein the operation cap operates like a screw following a fixing screw bolt, which is provided in the attachable pad body, so that the cap is pressed against the attachable pad body.

12. The attachable pad of claim 11, wherein the attachable pad body has a fixing screw nut, which is integrally molded thereto, wherein the fixing screw bolt is separated from the fixing screw nut, and is fixed to the fixing screw nut by selecting a size and length thereof as required.

13. The attachable pad of claim 11, wherein the cap has a through-hole through which the fixing screw bolt extends, and the pressing member is positioned around the through-hole.

14. The attachable pad of claim 5, further comprising a support means for supporting an object thereon, the support means being provided between the cap and the operation cap.

15. The attachable pad of claim 5, wherein the cap is integrally provided with a support means for supporting an object thereon.
